(19) United States
(12) Patent Application Publication
(10) Pub. No.: US 2026/0202000 A1
(43) Pub. Date: Jul. 16, 2026

(54) Tool Module for Carrier Robot and Machining Method Implemented by the Tool Module

(71) Applicant: BOUYGUES CONSTRUCTION EXPERTISES NUCLEAIRES, GUYANCOURT (FR)

(72) Inventors: Marc SEMBLAT, VINDRY-SUR-TURDINE (FR); Elodie MULLER, VINDRY-SUR-TURDINE (FR)

(21) Appl. No.: 19/444,946

(22) Filed: Jan. 9, 2026

(30) Foreign Application Priority Data
Jan. 13, 2025 (FR) 2500322

(51) Int. Cl. F16L 55/44; F16L 55/128; F16L 101/10; F16L 101/30

(52) U.S. Cl. CPC F16L 55/44; F16L 55/1283; F16L 2101/10; F16L 2101/30

(57) ABSTRACT

The present invention relates to a tool module (700) for a carrier robot (100) inserted into a first duct (1), the tool module (700) comprising a rotary body (701) extending along an extension axis (C), a centering device (60) and a tool (70) protruding from the rotary body (701), the centering device (60) comprising:
two reference rollers (71) movable between:
   a folded position;
   a deployed position in which each reference roller (71) protrudes from the rotary body (701) so as to bear against a wall of the first duct (1);
a push block (80) movable so as bear against a wall of the first duct (1) when the push block (80) and the reference rollers (71) are in their deployed position.

### FIELD OF THE INVENTION

The invention generally relates to the field of the monitoring and the maintenance, more specifically of the maintenance of the ducts, particularly the inspection and the intervention on the welds between the different sections of the ducts.

To this end, it proposes a tool module for a carrier robot comprising a centering device allowing the radial positioning in the duct of the tool module and a machining method implemented by this tool module.

The invention finds particularly advantageously-but without limitation application for the inspection and the shaving of the weld beads of the ducts of the nuclear facilities.

### STATE OF THE ART

Carrier robots incorporating one or more inspection or intervention tools used to monitor or operate inside a duct are known in the state of the art. Such a carrier robot typically comprises for example a flexible element linking different modules, the flexible element ensuring the communication and the energy supply of the modules. The elongated shape of the carrier robot allows distributing the modules ensuring its mobility, the inspection functions or the intervention functions along the length of the duct. The carrier robot is therefore typically elongated and of a large mass, of the order of at least several tens of kilograms.

The inspection or intervention tools require an accurate positioning of the module in the duct in order to operate on the designated area. Particularly, since the circumference of the module is necessarily smaller than that of the duct in order to allow the circulation of the carrier robot, a radial positioning of the tool carried by the module is necessary. In addition, in order to be able to travel the entire circumference of the duct, the module must also be able to assume any angular position.

### DISCLOSURE OF THE INVENTION

One aim of the present invention is to overcome the aforementioned drawbacks by proposing a tool module comprising a centering device that allows with accuracy any radial and angular displacement in the duct.

To this end, the invention proposes a tool module for a carrier robot inserted into a first duct, the tool module comprising a rotary body extending along an extension axis, a centering device and a tool protruding from the rotary body, the centering device comprising:
two reference rollers placed on the rotary body, each reference roller extending along a rotation axis parallel to the extension axis of the rotary body, the reference rollers being movable between:
   a folded position in which each reference roller is housed within the rotary body;
   a deployed position in which each reference roller protrudes from the rotary body so as to bear against a wall of the first duct;
a push block placed opposite to the reference rollers on the rotary body and comprising at least one bearing roller extending along a rotation axis parallel to the extension axis, the push block being movable perpendicularly to the extension axis between a folded position and a deployed position, such that the bearing roller bears against a wall of the first duct when the push block and the reference rollers are in their deployed position.

The invention is advantageously complemented by the following characteristics, taken separately or in any technically possible configuration:
each reference roller and bearing roller comprises two frustoconical parts linked together by a central part, a diameter of one end of each distal frustoconical part of the central part being greater than that of a proximal end of the tool, the central part forming a groove configured to receive a weld of the first duct;
a bearing roller or a reference roller is motorized so as to allow the rotation in the first duct of the tool module when the push block and the reference rollers are in their deployed position; the rotation of a bearing roller or of a reference roller against the first duct driving in rotation the rotary body;
the tool is a milling cutter configured to shave a weld of the first duct or an abrasive wheel configured to polish a weld of the first duct;
the rotary body comprises a jack configured to displace the push block and an electric motor configured to displace a reference roller between their respective folded position and deployed position;
the rotary body comprises an inertial unit configured to measure an angular displacement of the tool module in the first duct;
the rotary body comprises, between the push block and a reference roller, a centering laser configured to project a light spot onto the first duct;
the rotary body comprises, between the push block and a reference roller, a centering camera configured to observe the first duct perpendicularly to the rotary body;
the rotary body is in the shape of an oblong ellipsoid of revolution with respect to its extension axis, so as to allow the displacement of the tool module in an elbow duct;
the rotary body comprises deflectors, the deflectors being disposed so as to protrude from the rotary body in order to protect it;
the rotary body comprises first circulation casters disposed on either side of the push block and second circulation casters disposed on either side of the tool, the first circulation casters and the second circulation casters being configured to allow the displacement of the tool module in the first duct;
the second circulation casters are configured to be movable between a circulation position and a retracted position, the retracted position being assumed when the push block and the reference rollers are in their deployed position and the circulation position being assumed when the push block and the reference rollers are in their folded position;
a front module, the front module comprising:
   a first end linked to the rotary body by a flexible front link,
   a second end comprising a first camera,
   an inflatable tube disposed between the first end and the second end and configured to be inflated and deflated so as to obturate the first duct when it is inflated and to assume a stowed position in the front module when it is deflated;
a connection flange linked to the rotary body by a rear link, the connection flange comprising a second camera and lighting configured to respectively observe and illuminate the rotary body, and an interface configured to connect the tool module to a connection head.

The invention also relates to a machining method implemented by the tool module, the method comprising the following steps:
step F31: switching the reference rollers into the deployed position;
step F32: switching the push block into the deployed position;
step F53a: rotating the bearing rollers and the tool in opposite directions of rotation so as to perform a predetermined number of roughing passes.

### DESCRIPTION OF THE FIGURES

Other characteristics, aims and advantages of the invention will become apparent from the following description, which is purely illustrative and not limiting, and which should be read in relation the appended drawings, in which:

FIG. 1 illustrates a schematic view of the carrier robot, of various modules of the carrier robot, of the introduction guide and of the coiler according to one embodiment of the invention;

FIG. 2 is a schematic view of a tool module according to one embodiment of the invention;

FIG. 3 is a schematic profile view of a tool module according to one embodiment of the invention;

FIG. 4 is another schematic profile view of the tool module of FIG. 3;

FIG. 5 is another schematic profile view of the tool module of FIG. 4 in a first configuration;

FIG. 6 is a schematic profile view of the tool module of FIG. 5 in a second configuration;

FIG. 7 is a schematic detail view of the tool module of FIG. 6 inserted into a duct.

FIG. 8 illustrates the steps of a machining method performed by a tool module according to an embodiment of the invention.

In all figures, similar elements bear identical references.

### DETAILED DESCRIPTION OF THE INVENTION

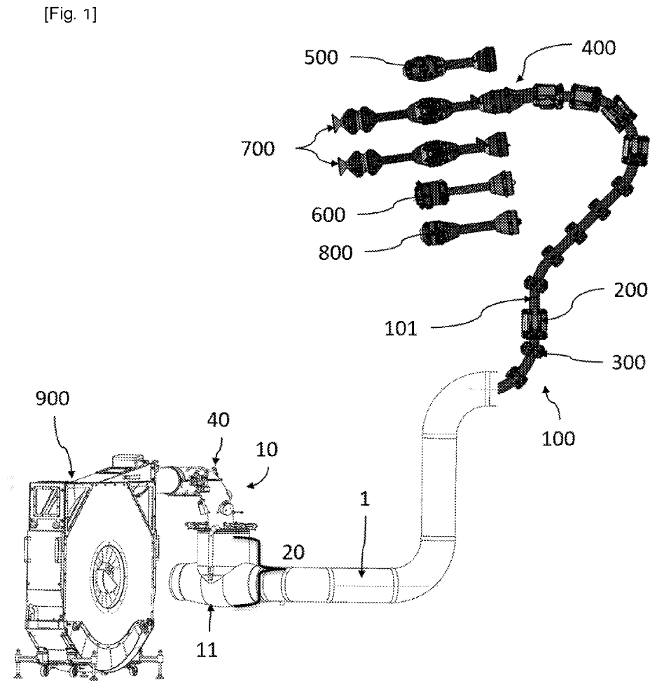

Referring to FIG. 1, the inspections and the interventions on the welds of a first duct 1 are performed by a carrier robot 100 comprising various modules. The carrier robot 100 comprises particularly a central hose 101, motor modules 200, freewheel modules 300, a connection head 400 to which a dimensional measurement module 500, a dye penetrant testing and televisual inspection (TVI) module 600, a tool module 700 or a cleaning module 800 can be connected. The central hose 101 contains the air, water, and energy supplies necessary to supply the various modules and also ensures communication between the modules and with a control station.

The carrier robot 100 is powered by motor modules 200 distributed along its length. Freewheel modules 300 also passively ensure the rolling of the carrier robot 100 on the inner walls of the first duct 1.

The dimensional measurement modules 500, the dye penetrant testing and TVI modules 600 are inspection modules used to check the condition of the first duct 1, for example before and after the intervention of the tool module 700. The tool module 700 and the cleaning module 800 are intervention modules.

These modules are interchangeable on the connection head 400. The shaving and polishing tools are typically mounted on the same tool module 700 interchangeably.

The other end of the carrier robot 100 is linked to a coiler 900 that ensures the necessary interfaces between the central hose 101, the control station and the required equipment, for example a high-pressure pump ensuring water supply, compressors for the air supply and a pump for the dye penetrant testing product supply. The coiler 900 also allows the storage of the carrier robot 100 in a small volume.

The introduction of the carrier robot 100 into the first desired duct 1 from the coiler 900 is facilitated by the use of an introduction guide 10, also called chistera.

### Tool Module

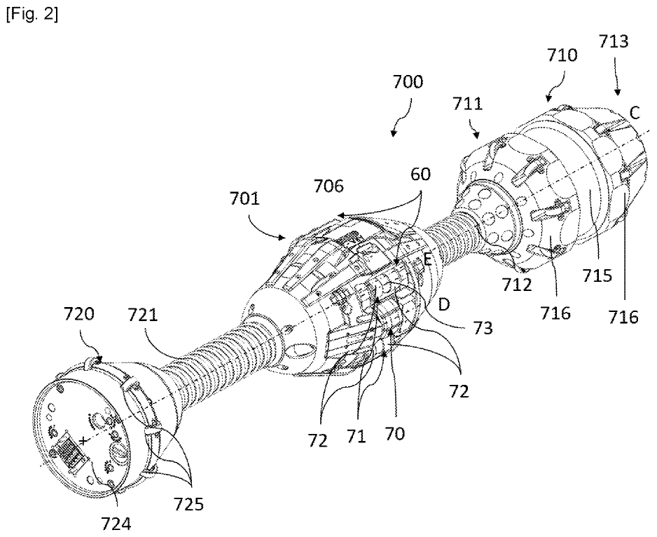

With reference to FIGS. 2 to 7, the tool module 700 comprises a central rotary body 701 extending along an axis C, the rotary body 701 carrying the tool 70 and a centering device 60. The tool module 700 also comprises a front module 710 and a connection flange 720 located respectively downstream and upstream of the rotary body 701 in the first duct 1 and linked respectively to the rotary body 701 by a front link 712 and a rear link 721.

The following will describe the case where the tool 70 is a milling cutter configured to shave a weld bead 5 of the first duct 1, or an abrasive wheel configured to polish a weld bead 5 of the first duct 1, in particular after shaving. However, the tool 70 can also be a set of dimensional measurements 90, although preferably such a set is mounted on a dimensional measurement module 500 described later.

The tool 70 has a cylindrical shape whose ridges are rounded in order to reduce friction against the first duct 1 during the displacement of the tool module 700, particularly in the case where the tool module 700 must cross the boundary between two distinct, misaligned sections of the first duct 1, for example when a straight section leads to a bend, a bend leads to another bend, or any other configuration of the type.

A shaving cutter preferably comprises high-speed steel (HSS). For a polishing operation, the abrasive wheel is for example a flap wheel comprising a fine-grained abrasive such as silicon carbide.

The rotary body 701 comprises a rotary spindle on which the tool 70 is removably mounted, the spindle being driven in rotation by a preferably pneumatic motor. A pneumatic circuit can also be configured to cool the tool 70. The tool 70 also comprises at least one suction channel configured to suction the debris produced during the shaving operation.

Once the carrier robot 100 is in a desired position of the first duct 1, that is to say on a weld bead 5, the central rotary body 701 positions the tool 70 in contact with the inner surface of the first duct 1 by means of the centering device 60. The centering device 60 of the invention also allows rotating the central rotary body 701 in order to perform passes with the tool 70 over the entire circumference of the first duct 1. By weld “bead” 5, it is meant the accumulation of material internal to the duct on its inner perimeter, this bead being formed following the weld 5 of two distinct sections of the first duct 1. The term “weld” may be used equally to designate this bead.

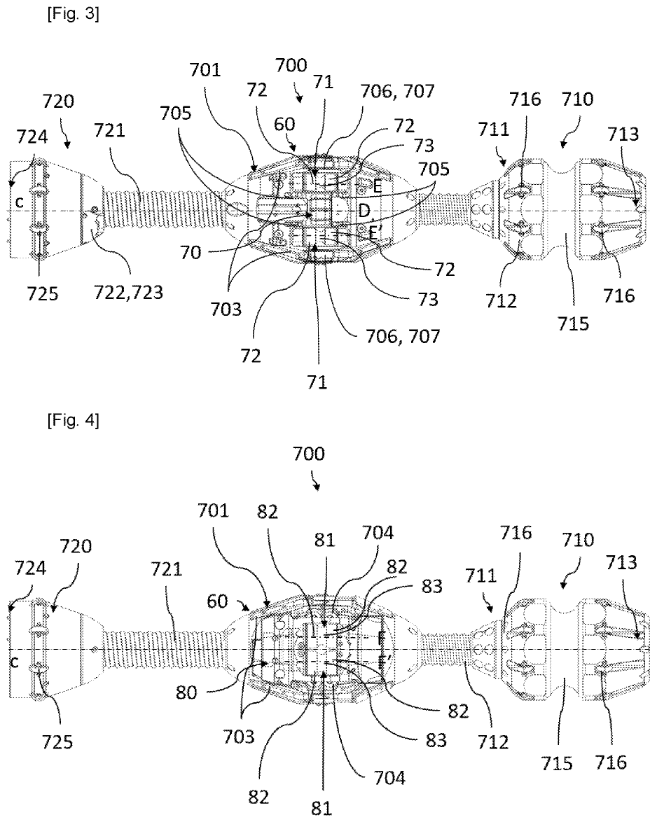

Thus, with reference to FIG. 3, the centering device 60 comprises two reference rollers 71 preferably placed on either side of the tool 70 on the rotary body 701. Each reference roller 71 extends along a rotation axis E, E′ parallel to a rotation axis D of the tool 70. Each reference roller 71 is configured to adapt to the geometry of the area surrounding the weld 5 of the first duct 1. As such, each reference roller 71 comprises two frustoconical parts 72 linked together by a central part 73. The diameter of one end of each distal frustoconical part 72 of the central part 73 is greater than that of a proximal end of the central part 73. The central part 73 forms a groove configured to receive a weld 5 of the first duct 1. A reference roller 71 therefore has a diabolo or hourglass shape, the central part 73 being a hyperboloid. Alternatively, when the area surrounding the weld 5 has a different geometry, the reference rollers 71 can be different and comprise, for example, a cylindrical shape.

In addition, the reference rollers 71 are movable between a folded position in which each reference roller 71 is housed in the rotary body 701, and a deployed position in which each reference roller 71 protrudes from the rotary body 701 so as to bear against a wall of the first duct 1. Advantageously, the rotary body 701 comprises, for each reference roller 71, a jack 702 configured to displace it from the folded position to the deployed position, preferably actuated by an electric motor. Alternatively, the jack 702 is a single-acting pneumatic jack. Advantageously, a pneumatic clutch is integrated on the transmission between the electric motor and a ball screw that translates the reference rollers 71. In the absence of compressed air, the transmission is disengaged, and return springs automatically bring back the reference rollers 71 to their retracted position.

Of course, the deployed position corresponds to a set of positions in which each reference roller 71 is more or less extended relative to the folded position. A position of maximum extension of the reference rollers 71 is particularly distinguished. The reference rollers 71 are preferentially held in the folded position during the displacement of the carrier robot 100 and in the deployed position when the rotary body 701 is in position at the weld bead. 5.

On the other hand, as illustrated in FIG. 4, the centering device 60 comprises a push block 80 placed opposite to the reference rollers 71 on the rotary body 701. The push block 80 comprises at least one bearing roller 81 extending on a rotation axis F, F′ parallel to the extension axis C. Preferably, the bearing rollers 81 have the same shape as the reference rollers 71. Thus, each bearing roller 81 comprises two frustoconical parts 82 linked together by a central part 83. The diameter of one end of each distal frustoconical part 82 of the central part 83 is greater than that of a proximal end of the central part 83. The central part 83 forms a groove configured to receive a weld bead 5 from the first duct 1. A bearing roller 81 has therefore preferably a diabolo or hourglass shape, the central part 83 being a hyperboloid. Again, the bearing rollers 81 may have a different shape to adapt to the weld bead 5, for example, a cylindrical shape.

Advantageously, the push block 80 comprises two bearing rollers 81 in order to increase the contact area with the first duct 1. Indeed, the push block 80 is movable perpendicularly to the extension axis C between a folded position and a deployed position, such that the bearing rollers 81 bear against the wall of the first duct 1 when the push block 80 and the reference rollers 71 are in their deployed position. The rotary body 701 comprises a jack 702 configured to displace the push block 80 from the folded position to the deployed position, preferably a single-acting pneumatic jack 702. Of course, the deployed position comprises a set of positions in which the push block 80 is more or less extended relative to the folded position. A maximum extension position of the push block 80 is particularly distinguished. In the deployed position, the push block 80 exerts a force on the wall of the first duct 1 so as to press the reference rollers 71 against the wall, in order to prevent any translation of the rotary body 701 upstream or downstream of the first duct 1 during the rotation of the rotary body 701 and of the tool 70.

The push block 80 also comprises an integrated geared motor configured to actuate the bearing rollers 81 in order to drive in rotation on the axis C the entire rotary body 701 in the first duct 1. Alternatively, the geared motor can be integrated out of the push block 80 into the rotary body 701 and then actuates at least one of the reference rollers 71 in order to drive in rotation the rotary body 701. The geared motor is dimensioned to counter the forces generated by the rotation of the tool 70. The geared motor preferably comprises a servo-controlled DC or brushless electric motor and a limit sensor. The bearing rollers 81 comprising a material configured to be a non-slip material, for example polyurethane. The reference rollers 71 preferably comprise a rigid material with low compression capacity in order to guarantee the accuracy of the positioning of the tool 70, for example polyamide.

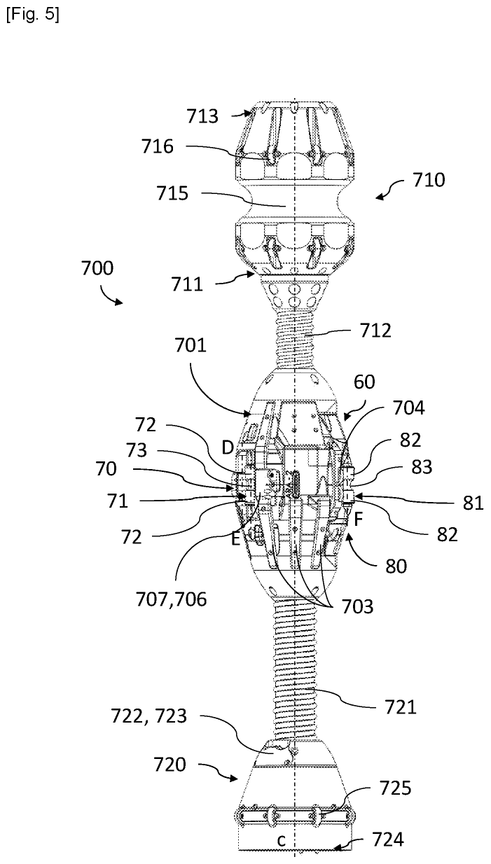

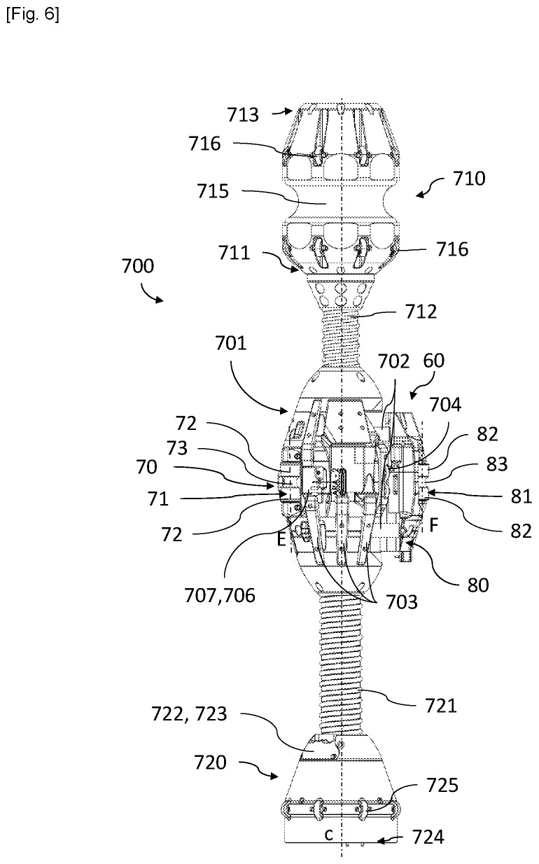

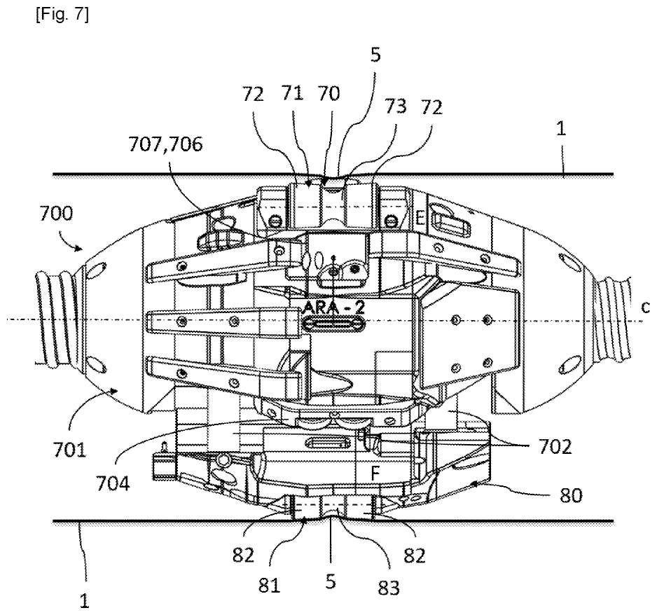

The reference rollers 71 and the push block 80 are in a folded position during the displacement of the carrier robot 100 in the first duct 1, as illustrated in FIG. 5. Once the rotary body 701 of the tool module 700 is aligned with the desired weld bead 5, the reference rollers 71 and the push block 80 are placed in the deployed position, for example by means of jacks 702, as illustrated in FIGS. 6 and 7. The shape of the reference rollers 71 allows centering the tool 70 relative to the weld 5 aligning the latter with the central part 73.

Indeed, there is on either side of each weld 5 a reduction in the diameter of the first duct 1, created during the welding 5. In other words, the first duct has a frustoconical section or inclined recesses on either side of the weld bead 5. The distal ends of each frustoconical part 72 of the central part 73 are configured to travel through these reductions during the rotation of the rotary body 701, in order to guide the tool 70 so that it follows the weld 5. During the switching from the retracted position to the deployed position, the reference rollers 71 and the bearing rollers 81 mechanically insert the distal end of each frustoconical part 72, 82 of the central part 73, 83 into the reductions on either side of the weld bead 5.

The variation of the extension of the jacks 702, and therefore of the distance between the rotary body 701, the reference rollers 71 and the push block 80 allows radially varying the position in the first duct 1 of the rotary body 701. This is specifically useful for positioning the tool 70 in the first duct 1, for example for setting a depth of cut when the tool 70 is a milling cutter or a bearing pressure when the tool 70 is an abrasive wheel.

The rotary body 701 is preferably in the shape of an oblong ellipsoid of revolution with respect to the axis C when the push block 80 is in the folded position. This shape allows an easier displacement of the tool module 700 in the first duct 1 and, in particular allows the passage of an elbow link, including successive elbow links, that is to say a bend leading directly to another bend. In addition, the frictions are reduced when the tool module 700 switches between two misaligned portions of the first duct 1.

Finally, this shape allows the intervention on a weld bead 5 between two elbows, or between a straight section and an elbow of the first duct 1. Indeed, the reference rollers 71 will conform to the inner surface of the first duct 1 and thus follow its inclination during the rotation of the rotary body 701, which allows, during successive passes of the tool 70, perfectly connecting the surfaces upstream and downstream of the weld bead 5 and therefore never forming a concave area or a “stepped” shape at this weld bead 5.

The ends of the rotary body 701 comprise respectively the front link 712 and the rear link 721 and thus appear truncated.

The equator of the rotary body 701, in other words the widest perimeter of the rotary body 701 inscribed in a plane perpendicular to the axis C, comprises the centering device 60 and the tool 70. More precisely, the respective centers of the tool 70, of the reference rollers 71 and of the bearing rollers 81 belong respectively to the rotation axes D, E, E′, F and F′ and to the equator of the rotary body 701. In other words, in the folded position of the reference rollers 71 and of the push block 80, the centers of the central parts 73 and 83 do not protrude from the rotary body 701. On either side of the equator of the rotary body 701, the tool module 700 comprises deflectors 703 disposed so as to protrude from the rotary body 701 in order to protect it. These deflectors 703 are preferably flaps distributed on the periphery of the rotary body 701 upstream and downstream of the equator, in order to absorb shocks and friction during the displacement of the carrier robot 100. The deflectors 703 are advantageously removable so that they can be replaced when damaged.

In order to further facilitate the circulation of the module in the first duct 1, the rotary body 701 further comprises first circulation casters 704 disposed on either side of the push block 80 and second circulation casters 705 disposed on either side of the tool 70. The second circulation casters 705 are preferably disposed as a pair upstream and a pair downstream of the tool 70, radially between each reference roller 71 and the tool 70. The first circulation casters 704 comprise two pairs of free wheels placed on the equator of the rotary body 701 and the second circulation casters 705 comprise four free wheels framing the tool 70. Advantageously, the second circulation casters 705 are movable between a circulation position and a retracted position.

In the circulation position, the second circulation casters 705 are configured to allow the displacement of the tool module 700 in the first duct 1. Particularly, the second circulation casters 705 frame the tool 70 in order to prevent the contact between the tool 70 and the wall of the first duct 1.

In the retracted position, which is assumed when the push block 80 and the reference rollers 71 are in their deployed position, the second circulation casters 705 are stowed inside the rotary body 701 in order to allow the tool 70 to come into contact with the wall of the first duct 1.

Advantageously, the rotary body 701 further comprises an inertial unit configured to measure an angular displacement of the tool module 700 in the first duct 1. Thus, it is possible to know the position of the rotary body 701 and particularly of the tool 70 when the rotary body 701 is in rotation under the action of the bearing rollers 81. The rotational movement of the rotary body 701 is then servo-controlled so as to perform on the weld 5 a predetermined number of passes of the tool 70, in a selected direction and at a selected speed 5.

In addition, the rotary body 701 may comprise a centering camera 707 and/or a centering laser 706, advantageously two pairs of centering laser 706 and centering camera 707 positioned in the vicinity of each reference roller 71. Preferably, the centering camera 707 and/or the centering laser 706 are aligned with the centers of the tools 70, of the reference rollers 71 and of the bearing rollers 81. Thus, the centering camera 707 and/or the centering laser 706 can be used to find the weld 5 and when aligned with the optical axis, the displacement of the tool module 700 can be stopped. Each centering laser 706 is configured to project a point visible to the centering camera 707 onto the inner surface of the first duct 1, in order to serve as a visual mark for the operator. Preferably, the centering camera 707 comprises a lighting.

Each centering camera 707 allows visualizing the weld 5 during the displacement of the carrier robot 100 in order to position the tool module 700 relative to the weld 5 before switching the reference rollers 71 and the push block 80 from their folded position to the deployed position. On the other hand, the centering camera 707 also allows monitoring the shaving or polishing operations by visually inspecting the weld 5.

The front module 710 is located downstream of the rotary body 701 and is linked to it by a flexible front link 712 extending from a first end 711. The front link 712 is a hose provided with a vertebra, flexible in curvature but rigid in compression, connecting the front module 710 with the rotary body 701 in order to allow the passage of the tool in the elbows of the pipe. The front link 712 also allows passing pneumatic and electrical utilities. In order to allow these connections with the rotary body 701, the front link 712 comprises a rotating pneumatic manifold.

The first end 711 comprises a circular profile and a diameter that gradually increases from the front link 712, for example a frustoconical or funnel shape in order to facilitate the displacement of the carrier robot 100. For the same purpose, the first end 711 comprises on its outer surface a set of freewheels 716 distributed over the entire circumference so as to reduce friction.

The front module 710 also comprises a second end 713 also comprising a set of freewheels 716 and a first camera 714. The second end preferably has a frustoconical shape in order to pass the elbow links of the first duct 1. The first camera 714 faces downstream and is configured to acquire images of the first duct 1 during the displacement of the carrier robot 100. Advantageously, the first camera 714 comprises a lighting.

An inflatable tube 715 configured to be inflated and deflated extends between the first end 711 and the second end 713. When deflated, the tube 715 is stored in such a way as to adopt a groove shape, in other words, a hyperboloid shape, that is to say it adopts a re-entrant shape in order to prevent any damage to the tube during the displacement of the carrier robot 100 in the first duct 1. When inflated, the tube 715 has a diameter sufficient to obturate the first duct 1 in order to isolate it from the tool module 700 and from the particles generated by the shaving and/or polishing operations.

The connection flange 720 is linked to the rotary body 701 by a rear link 721. The rear link 721 is a hose provided with a vertebra, flexible in curvature but rigid in compression, connecting the connection flange 720 with the rotary body 701 in order to allow passage of the tool module 700 in the elbows of the pipe. The rear link 721 also allows passing pneumatic and electrical utilities, as well as the suction hoses for the suction channel of the tool 70. In order to allow these connections with the rotary body 701, the rear link 721 comprises a rotating manifold.

The connection flange 720 comprises a second camera 722 and a lighting 723 configured to respectively observe and illuminate the rotary body 701 so as to be able to monitor the machining operations and the changes in position of the reference rollers 71 and of the push block 80. The connection flange 720 also comprises an interface 724 configured to connect the tool module 700 to a connection head 101. The interface 724 ensures the air, electrical connections and any other necessary servitude between the tool module 700 and the rest of the carrier robot 100.

### Machining Method

The tool module 700 described previously allows the implementation of a method for machining the first duct 1. The method will subsequently be described within the framework of the shaving a weld 5 present on a circumference between two sections of the first duct 1. That is to say the tool 70 is a shaving cutter configured to make passes along the weld 5 in order to remove material, but this method is applicable to the polishing and to any other type of operation.

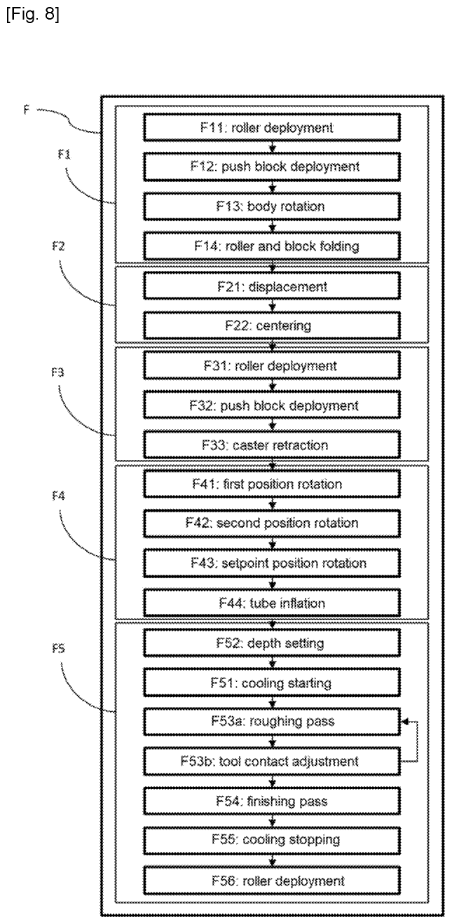

With reference to FIG. 8, the machining method F comprises a phase of positioning F1 the tool 70, a displacement phase F2, a clamping phase F3, an initialization phase F4 and a machining phase F5.

The positioning phase F1a aims to place the tool 70 in a position that allows the displacement of the carrier robot 100 in the first duct 1 without damaging the tool 70. In this position, the tool 70 is placed as an upper generatrix of the first duct 1, in other words, when the first duct is horizontal relative to the ground, the tool module 700 is oriented so that the tool 70 is at a distal point on the ground. To achieve this goal, the positioning phase F1 comprises the following steps:
deploying the reference rollers 71 (step F11) and the push block 80 (step F12) from their folded position to their respective deployed position;
rotating the bearing rollers 81 in order to rotate the rotary body 701 until reaching the desired angular position of the tool 70, the angular position being continuously measured by the inertial unit and compared with the desired position, so that the rotation of the bearing rollers 81 is stopped when the angular position is equal to the desired angular position (step F13);
putting in the folded position the reference rollers 71 of the push block 80 (step F14).

The positioning phase F2 aims to position the tool 70 opposite the weld 5, so that the rotation of the rotary body 701 passes the tool over the entire circumference of the weld 5. The positioning phase F2 comprises the following steps:
displacing the tool module 700 upstream or downstream by using the centering cameras 707 and/or the centering lasers 706 and/or the second camera 722 in order to bring the rotary body 700 close to the weld bead 5 (step F22);
centering the tool 70 on the weld bead 5 and stopping the displacement when the tool 70 is aligned with the weld bead 5, preferably when the radius of the centering laser 706 is positioned at the center of the weld bead 5 (step F23).

Once the rotary body 701 of the tool module 700 is in position, the clamping phase F3 can be carried out in order to prevent any translation of the rotary body 701 in the first duct 1. The clamping phase F3 comprises the following steps:
switching the reference rollers 71 into the deployed position so as place them at their maximum possible extension of their deployed position, with the distal end of each frustoconical part 72 of the central part 73 being inserted into the diameter reductions of the first duct 1 on either side of the weld bead 5, the central parts 73 and the tool 70 being opposite the weld bead 5 (step F31);
switching the push block 80 into the deployed position, with the distal end of each frustoconical part 82 of the central part 83 of the bearing rollers 81 being inserted into the diameter reductions of the first duct 1 on either side of the weld bead 5, the central parts 73 and the tool 70 being opposite the weld bead 5 (step F32);
retracting the circulation casters 705 of the rotary body 701 (step F33).

The initialization phase F4 allows preparing the tool module 700 for the machining phase F5, isolating the downstream of the first duct 1, and comprises the following steps:
rotating the rotary body 701 so that the tool 70 reaches a first angular position corresponding to a first contact of the limit sensor, that is to say in the first angular position, the limit sensor returns a predetermined value associated with an angle equal to that of the first angular position, for example 0° (step F41);
-rotating the rotary body 701 so that the tool 70 reaches a second angular position corresponding to a second contact of the limit sensor, that is to say in the second angular position, the limit sensor returns a predetermined value associated with an angle equal to that of the second angular position, for example 720° (step F42). In other words, after having determined its position during step F41, the rotary body 701 makes two complete rotations on its rotation axis C, in order to allow the reference rollers 71 and the bearing rollers 81 to be positioned on either side of the weld bead 5;
rotating the rotary body 701 until the tool 70 reaches a angular position with a predetermined setpoint (step F43);
inflating the tube 715 of the front module 710, the tube conforming to the entire circumference of the first duct 1 in order to isolate the downstream of the first duct 1 from the residues produced by the machining (step F44).

The machining phase F5 comprises the following steps:
setting the machining depth, the machining depth being a distance between the tool 70 and the surface of the first duct 1, determined when the reference rollers 71 are extended to the maximum possible of their deployed position from the angle of the diameter reductions of the first duct 1 on either side of the weld bead 5 and of a width of the weld bead 5, the respective angle of the diameter reductions of the first duct 1 on either side of the weld bead 5 and the width of the weld bead 5 being advantageously determined by the dimensional measurement module 500 (step F51), the reference rollers 71 being deployed in a position in which the tool 70 is in contact with the weld bead 5;
starting the cooling of the tool 70 (step F52);
rotating the rotary body 701 by the bearing rollers 81 and the tool 70 in opposite directions of rotation, so as to perform a predetermined number of roughing passes in which the tool 70 works in opposition (step F53a);
modifying the position of the reference rollers 71 and/or of the push block 80a in order to maintain the contact between the weld bead 5 and the tool 70 (step F53b), preferably between two roughing passes, for example at a regular interval of rotations of the rotary body 701 (that is to say between two steps F53a). Steps F53a and F53b are therefore performed iteratively;
reversing the direction of rotation of the tool 70 on the axis E, or the direction of rotation of the rotary body 701 on the axis C, so as to perform a finishing pass (step F54) in which the tool 70 works by going downstream before the rotation of the rotary body 701 and of the tool 70 stops;
stopping the cooling of the tool 70 (step F55);
switching the reference rollers 71 into the deployed position at the maximum extension possible of their deployed position (step F56).

The tool module 700 according to present disclosure allows for time savings and accuracy on the inspection and intervention operations, and as such is specifically adapted to the operations on all types of ducts, for example those belonging to the safety injection circuit (RIS) of a nuclear facility.

1. A tool module for a carrier robot inserted into a first duct, the tool module comprising a rotary body extending along an extension axis, a centering device and a tool protruding from the rotary body, the centering device comprising:
two reference rollers placed on the rotary body, each reference roller extending along a rotation axis parallel to the extension axis of the rotary body, the reference rollers being movable between:
a folded position in which each reference roller is housed within the rotary body;
a deployed position in which each reference roller protrudes from the rotary body so as to bear against a wall of the first duct;
a push block placed opposite to the reference rollers on the rotary body and comprising at least one bearing roller extending on a rotation axis parallel to the extension axis, the push block being movable perpendicularly to the extension axis between a folded position and a deployed position, such that the bearing roller bears against a wall of the first duct when the push block and the reference rollers are in their deployed position.

2. The tool module according to claim 1, wherein each reference roller and bearing roller comprises two frustoconical parts linked together by a central part, a diameter of one end of each distal frustoconical part to the central part being greater than that of a proximal end of the tool, the central part forming a groove configured to receive a weld of the first duct.

3. The tool module according to claim 1, wherein a bearing roller or a reference roller is motorized so as to allow the rotation in the first duct of the tool module when the push block and the reference rollers are in their deployed position, the rotation of a bearing roller or of a reference roller against the first duct driving in rotation the rotary body.

4. The tool module according to claim 1, wherein the tool is a milling cutter configured to shave a weld of the first duct or an abrasive wheel configured to polish a weld of the first duct.

5. The tool module according to claim 1, wherein the rotary body comprises a jack configured to displace the push block (80) and an electric motor configured to displace a reference roller between their respective folded position and deployed position.

6. The tool module according to claim 1, further comprising an inertial unit configured to measure an angular displacement of the tool module in the first duct.

7. The tool module according to claim 1, wherein the rotary body comprises, between the push block and a reference roller, a centering laser configured to project a light spot onto the first duct.

8. The tool module according to claim 1, wherein the rotary body comprises, between the push block and a reference roller, a centering camera configured to observe the first duct perpendicularly to the rotary body.

9. The tool module according to claim 1, wherein the rotary body is in the shape of an oblong ellipsoid of revolution with respect to its extension axis, so as to allow the displacement of the tool module in an elbow duct.

10. The tool module according to claim 1, wherein the rotary body comprises deflectors, the deflectors being disposed so as to protrude from the rotary body in order to protect it.

11. The tool module according to claim 1, wherein the rotary body comprises first circulation casters disposed on either side of the push block (80) and second circulation casters disposed on either side of the tool, the first circulation casters and the second circulation casters being configured to allow the displacement of the tool module in the first duct.

12. The tool module according to claim 1, wherein the second circulation casters are configured to be movable between a circulation position and a retracted position, the retracted position being assumed when the push block and the reference rollers are in their deployed position and the circulation position being assumed when the push block and the reference rollers are in their folded position.

13. The tool module (700) according to claim 1, comprising a front module, the front module comprising:
a first end linked to the rotary body by a flexible front link,
a second end comprising a first camera,
an inflatable tube disposed between the first end and the second end and configured to be inflated and deflated so as to obturate the first duct when it is inflated and to assume a stowed position in the front module when it is deflated.

14. The tool module according to claim 1, comprising a connection flange linked to the rotary body by a rear link, the connection flange comprising a second camera and a lighting configured to respectively observe and illuminate the rotary body, and an interface configured to connect the tool module to a connection head.

15. A machining method implemented by a tool module for a carrier robot inserted into a first duct, the tool module comprising a rotary body extending along an extension axis, a centering device and a tool protruding from the rotary body, the centering device comprising:
two reference rollers placed on the rotary body, each reference roller extending along a rotation axis parallel to the extension axis of the rotary body, the reference rollers being movable between:
a folded position in which each reference roller is housed within the rotary body;
a deployed position in which each reference roller protrudes from the rotary body so as to bear against a wall of the first duct;
a push block placed opposite to the reference rollers on the rotary body and comprising at least one bearing roller extending on a rotation axis parallel to the extension axis, the push block being movable perpendicularly to the extension axis between a folded position and a deployed position, such that the bearing roller bears against a wall of the first duct when the push block and the reference rollers are in their deployed position.
, the method comprising the following steps:
step F31: switching the reference rollers into a deployed position;
step F32: switching the push block into the deployed position;
step F53a: rotating the bearing rollers and the tool in opposite directions of rotation so as to perform a predetermined number of roughing passes.
